(19) United States
(12) Patent Application Publication
(10) Pub. No.: US 2017/0083935 A1
(43) Pub. Date: Mar. 23, 2017

(54) METHODS AND SYSTEMS FOR DETERMINING A RETARGETING SEQUENCE OF ADVERTISEMENTS ACROSS PLATFORMS

(71) Applicant: ROVI GUIDES, INC., Santa Clara, CA (US)

(72) Inventors: Benjamin H. Maughan, Pleasanton, CA (US); Sean Matthews, Los Altos, CA (US)

(21) Appl. No.: 14/859,220

(22) Filed: Sep. 18, 2015

(51) Int. Cl. G06Q 30/02

(52) U.S. Cl. CPC G06Q 30/0244

(57) ABSTRACT

Methods and systems are described herein for determining a retargeting sequence of advertisements that transition between displaying a first advertisement at a first platform and displaying a second advertisement at a second platform, where the advertisements of the sequence are related by metadata. The retargeting sequence of advertisements may be determined based on a user's viewing habits with reference to a first item, and applied to promotion of a second item.

### BACKGROUND

In conventional systems, advertisements are targeted to users through a variety of different platforms (e.g., social networks, e-mail, etc.). Although each of the platforms targets advertisements to users based on information about the users (e.g., search terms entered by a user, web pages selected by a user, application menu options selected by a user) that is gathered through each respective platform, the platforms do not utilize information about a sequence in which advertisements are presented to, or selected by, a user across different platforms, prior to the execution of activity promoted by the advertisements (e.g., scheduling of a recording, subscription to a service, etc.). Additionally, the platforms do not utilize information about users that is gathered based on viewing habits of media assets (e.g., broadcast programs, on-demand programs, recorded programs) because such information (e.g., television viewing habits) has been gathered independently of other platforms.

### SUMMARY

Accordingly, methods and systems are disclosed herein for switching between platforms for displaying targeted advertisements to a user. Advertisements are displayed at an appropriate frequency across each of a number of platforms in order to most effectively cause a user to perform a conversion event. For example, a system may determine that a user using a first platform has viewed a first advertisement that corresponds to first metadata (e.g., one or more fields that describes a media asset). The system may increment a count of a number of times that the user has viewed any of a first plurality of advertisements that correspond to the first metadata. The system may determine whether the count exceeds a threshold, indicating that retargeting of advertisements through a second platform should commence. In response to determining that the count exceeds a threshold, the system calculates a plurality of correlation metrics to select a second advertisement from a plurality of candidate advertisements that best matches the first displayed advertisement. The system then causes the selected second advertisement to be displayed.

For example, in response to determining that a user has viewed, using a first platform (e.g., video commercial advertisements through an electronic program guide application platform), a first advertisement (e.g., for a music band) of a first plurality of advertisements that correspond to first metadata (e.g., for the music band), a system may increment a count of a number of times that the user has viewed any advertisement of the plurality of advertisements. The system may subsequently determine that the count exceeds a threshold, indicating that retargeting of advertisements from the first platform (e.g., the electronic program guide application platform) to a second platform (e.g., a social network platform) should take place. In response to determining that the count exceeds the threshold, the system may calculate a plurality of correlation metrics between the first metadata (e.g., for the music band) and metadata of each of a plurality of candidate advertisements (e.g., a plurality of advertisements related to upcoming performances for the same and/or several different music bands), and select a second advertisement (e.g., for an upcoming performance of the music band of the first advertisement) that has a highest correlation metric of the plurality of correlation metrics to find a best match between the first advertisement and the second advertisement of the plurality of candidate advertisements. The system may subsequently cause the second advertisement (e.g., for the upcoming musical performance of the music band) to be displayed by way of the second platform (e.g., the social network platform) that is different from the first platform (e.g., the electronic program guide application platform) for display to the user.

In some aspects, control circuitry of a server may calculate the plurality of correlation metrics between the first metadata of the first plurality of advertisements and the metadata of each of the candidate advertisements by determining a count of intersecting metadata fields between the first metadata and the metadata of each of the candidate advertisements. For example, first metadata may include the fields (Music->Band->LinkinPark) and metadata of a first candidate advertisement may include the fields (Music->Solo->Madonna->PerformanceDate) and a second candidate advertisement may include the fields (Music->Band->LinkinPark->PerformanceDate). Control circuitry may determine that a correlation metric between the first metadata and metadata of the first candidate advertisement is the value 1 (e.g., 1 intersection of the “Music” field), and may determine that a correlation metric between the first metadata and metadata of the second candidate advertisement is the number 3 (e.g., 3 intersections of the fields “Music”, “Band” and “LinkinPark”). The correlation metrics may be used to select the candidate advertisement for display. For example, control circuitry may select the second candidate advertisement having the highest correlation metric among the two candidate advertisements.

In some aspects, control circuitry may receive a record of an access event, or exposure event, by the user by way of the second platform, calculate a second correlation metric between metadata of the access event and the metadata of the second advertisement. Control circuitry may then determine that the second correlation metric exceeds a threshold, and in response, cause the second advertisement to be displayed using the second platform. For example, control circuitry may receive a notification that a user has accessed a social network platform via a web browser (e.g., detected by receipt of a cookie from the web browser) and is viewing a page related to a music band. Control circuitry may calculate a correlation metric by comparing metadata for the web page (e.g., Music->Band->LinkinPark), and metadata for a selected second advertisement (e.g., Music->Band->LinkinPark), as the value 3, and determine that it exceeds a threshold (e.g., 1). In response, control circuitry of a server may cause the selected second advertisement to be displayed at the webpage, for example, by using a command from an application programming interface (API) of the second platform to send a command to display the selected second advertisement based on an identifier of the selected second advertisement.

In some aspects, control circuitry may determine that the user using the first platform and that the user viewing the advertisement by way of the second platform are the same user based on at least one of an e-mail address, a phone number, a home street address, a GPS location, a user account identifier (e.g., a username), an IP address, a MAC address, a user identification number and a cookie. For example, control circuitry of a server may determine that a user of a first platform (e.g., an e-mail platform), and a user of a second platform (e.g., a social network), are the same user based on the e-mail address of the user used to access both platforms, for example, by receiving the identity of a user by using a command from an API of the first platform (e.g., e-mail platform) to retrieve an identifier of the first user and by using a command from an API of the second platform (e.g., social network platform) to retrieve an identifier of the second user from the second platform.

In some embodiments, control circuitry of a server or a user equipment device may determine that a user that is using a first platform has viewed an advertisement by receiving an indication from the first platform that the user has remained at a location proximate to a display of the first advertisement for a minimum period of time. For example, the first platform may be an electronic signboard advertising platform. Control circuitry of a server or a user equipment device may determine that the user has remained at a location proximate to the billboard for a minimum period of time (e.g., two minutes).

In some embodiments, the first platform may be an electronic program guide. For example, control circuitry of a user television equipment may determine that a user has viewed an advertisement generated for display through an electronic program guide.

In some aspects, the first advertisement that corresponds to the first metadata is a video generated for display during at least one of a scheduled transmission of a media asset (e.g., a broadcast program), an unscheduled transmission of a media asset (e.g., an on-demand program), or an unscheduled playback of a media asset (e.g., a media asset recorded on a DVR). For example, control circuitry of a user television equipment may determine that during a broadcast television program, a first video commercial advertisement was generated displayed to a user.

In some aspects, control circuitry of a server or a user television equipment may receive an indication from the first platform that the video of the first advertisement corresponding to first metadata is generated for display for a minimum period of time, and in response, increment the count of the number of times that the user has viewed any advertisement that corresponds to the first metadata. For example, control circuitry of a server of a user television equipment may determine that a user has viewed a commercial for an upcoming performance of a music band by determining that the video has been displayed for a minimum amount of time without interruption from fast-forward commands.

In some aspects, control circuitry of a server or a user equipment device may determine a level of sufficient interest by the user in the video of the first advertisement based on an attentiveness level of the first user received from imaging circuitry. For example, a user television equipment may include a camera. Control circuitry of the user television equipment may determine that a user's face and eyes are detected and directed towards a display of the user television equipment for a minimum period of time during display of the video of the first advertisement.

In some embodiments, control circuitry of a server may receive a first record indicating that the user has viewed the first advertisement, where the first record includes an identifier of a user profile of the user, an identifier of the first advertisement and a time stamp of when the user viewed the first advertisement. Control circuitry of the server may receive a second record indicating that the user has viewed the second advertisement, where the second record includes an identifier of a user profile of the user, an identifier of the second advertisement and a time stamp of when the user viewed the second advertisement. For example, control circuitry of a server may receive a record from an electronic program guide platform (e.g., the first platform) when control circuitry of a user television equipment has determined that a viewer has viewed the first advertisement for a minimum period of time. Control circuitry of the server may receive a record from a social network platform (e.g., the second platform) when control circuitry of a user equipment device determines that a second advertisement has been displayed to the user using the social network platform (e.g., through a mobile application or through a web page displayed in a browser).

In some embodiments, control circuitry determines a retargeting sequence in which advertisements are generated for display using a first platform (e.g., an electronic program guide application platform) and a second platform (e.g., a social network platform). For example, a system may monitor when a user has viewed advertisements using a first platform (e.g., an electronic program guide application platform) and a second platform (e.g., a social network platform) where the viewed advertisements have metadata that are correlated (e.g., advertisements for a product). The system may then determine that a first conversion event has occurred (e.g., the user has commenced a process of acquiring the product), which indicates that the prior sequence of display of advertisements was successful in causing the conversion event.

The system may determine a retargeting sequence of subsequent display of advertisements to effect a second conversion event, based on the times that the advertisements were viewed on the first platform and the second platform, and the time of the first conversion event. The system may then execute the retargeting sequence to display a sequence of advertisements on the first platform and second platform, based on the times when the advertisements were previously displayed. The system may determine a predicted time of occurrence of the second conversion event and cause the display, at the predicted time of the second conversion event of an advertisement having a highest correlation (e.g., a best match) between the advertisements displayed on the first platform and the second platform.

For example, control circuitry may determine when a user, using the first platform (e.g., an electronic program guide platform), has viewed a first advertisement (e.g., a video commercial for a Lexus car) of a first plurality of advertisements that correspond to first metadata (e.g., Car->Lexus; Video Ad). The control circuitry may determine when the user using the second platform (e.g., a social network platform) has viewed a second advertisement (e.g., a banner advertisement of a Lexus Car Test Drive Offer) of a second plurality of advertisements corresponding to second metadata, where the second metadata and the first metadata are correlated (e.g., by a highest number of matches of metadata fields).

The control circuitry may determine that, within a predefined period from a time at which the user viewed (e.g., using the social network platform) an advertisement of the second plurality of advertisements, that a first conversion event (e.g., a selection of the advertisement) has occurred by way of the second platform. The control circuitry may determine a retargeting sequence for subsequent display, by way of the first platform and the second platform, of advertisements selected from the first plurality of advertisements (e.g., video commercials for Lexus cars) and the second plurality of advertisements (e.g., advertisements embedded in a webpage or mobile application related to Lexus Cars), in response to determining that the first conversion event has occurred.

The control circuitry may execute the retargeting sequence, where the retargeting sequence includes causing to be displayed, by way of the first platform, an advertisement (e.g., a video commercial of another Lexus car) of the first plurality of advertisements, and by way of the second platform, an advertisement (e.g., a thumbnail advertisement of the Lexus logo) of the second plurality of advertisements. The control circuitry may determine a predicted time of occurrence of the second conversion event (e.g., a second section of an advertisement displayed using the second platform), based on, for example, a time difference between a time of display of the first advertisement in a prior sequence and a time of the first conversion event. The control circuitry might determine the predicted time of the second conversion event as the time of display of the first advertisement in the retargeting sequence, added to the time difference from the prior sequence.

The control circuitry may cause to be displayed, by way of the second platform, an advertisement from the second plurality of advertisements having a highest correlation to the first metadata (e.g., a video advertisement for a Lexus car that can be generated for display within a web page of the social network platform), to the user at the predicted time of occurrence of the second conversion event. For example, control circuitry may calculate a correlation metric by determining the number of intersecting metadata fields between first metadata (e.g., including the metadata “Car->Sedan->Lexus->[Year2015,IS350]; VideoAd”) of the first plurality of advertisements and metadata (e.g., including the metadata “Car->SUV->Lexus->Testdrive; Dealership->Address1”) of an advertisement from the second plurality of advertisements. Control circuitry may determine that there are two intersecting metadata fields and, accordingly, a correlation metric is two. Control circuitry may compute a correlation metric for each of the other advertisements from the second plurality of advertisements and select the advertisement having the highest correlation metric with the first metadata, for generation for display to a user.

In some embodiments, control circuitry of a server or a user equipment device may determine that a user that is using a first platform has viewed an advertisement by receiving an indication from the first platform that the user has remained at a location proximate to a display of the first advertisement for a minimum period of time. For example, the first platform may be an electronic billboard advertising platform. Control circuitry of a server or a user equipment device may determine that the user has remained at a location proximate to the billboard for a minimum period of time (e.g., two minutes) based on measurements of location taken using a user equipment device of the user.

In some embodiments, the first platform may be an electronic program guide. For example, control circuitry of a user television equipment may determine that a user has viewed an advertisement generated for display through an electronic program guide application platform by determining that a channel change command was not received during the display of the advertisement.

In some aspects, the first conversion event may include determining that the user has remained at a location correlated to the first metadata and the second metadata for a minimum period of time. For example, control circuitry of a user equipment device may determine that a user has entered a Lexus car dealership and remained at the dealership for longer than 10 minutes. The first conversion event may include receiving a user selection of the second advertisement. For example, control circuitry of a user equipment device may receive a selection of a video advertisement that was generated for display to the user using a social network platform. The first conversion event may include receiving an order of an item correlated to the first metadata and the second metadata. For example, control circuitry of a server may generate for display a series of advertisements related to a chess program. Control circuitry may receive an order to download the chess board game to a user equipment device of a user, through a social network platform.

In some embodiments, control circuitry may store to a first data structure time stamps of when the user viewed, using the first platform, any advertisements of the first plurality of advertisements. For example, control circuitry may store a number of records, including a time stamp of when an advertisement was generated for display or viewed, an identifier of the advertisement, and/or an identifier of the first platform used. Control circuitry may store to a second data structure time stamps of when the user viewed, using the second platform, any advertisements of the second plurality of advertisements. For example, control circuitry may store a number of records, including a time stamp of when an advertisement was generated for display or viewed, an identifier of the advertisement, and/or an identifier of the second platform used.

Control circuitry may determine the retargeting sequence by ordering the time stamps stored in the first data structure and the time stamps stored in the second data structure. For example, control circuitry may load the records of the first data structure and the records of the second data structure into a database, and store the database by time stamp to generate a sequence in which advertisements were displayed using the first platform and second platform. Control circuitry may generate a sequence in which advertisements from the first plurality of advertisements and the second plurality of advertisements are displayed, based on the ordering of the time stamps stored in the first data structure and the time stamps stored in the second data structure, wherein the sequence comprises a pluralities of entries indicating the first platform or the second platform. For example, control circuitry may generate a new data structure based on an export of the sorted records from the database. Control circuitry may store, as part of the retargeting sequence, the generated sequence. For example, control circuitry may store the new data structure as part of a data structure for the retargeting sequence that may include other information such as rules.

In some embodiments, control circuitry may execute the retargeting sequence by determining that a first entry of the sequence indicates the first platform. For example, control circuitry may determine that a first record of the new data structure includes an identifier of the first platform (e.g., an electronic programming guide application platform). Control circuitry may, in response to determining that the first entry of the sequence indicates the first platform, cause an advertisement (e.g., a video advertisement for a Lexus Sedan) of the first plurality of advertisements (e.g., video advertisements for various Lexus cars) to be displayed, by way of the first platform (e.g., an electronic programming guide application platform), to the user (e.g., on a television). For example, control circuitry may select an advertisement from the first plurality of advertisements and generate for display the advertisement using the first platform.

Control circuitry may determine that a second entry of the sequence indicates the second platform (e.g., a social network platform). For example, control circuitry may determine that a second record of the new data structure includes an identifier of the second platform. Control circuitry may, in response to determining that the second entry of the sequence indicates the second platform (e.g., the social network), cause an advertisement (e.g., a graphical advertisement for a test drive offer at a dealership) of the second plurality of advertisements (e.g., graphical advertisements for Lexus cars) to be displayed, by way of the second platform, to the user. For example, control circuitry may select an advertisement of the second plurality of advertisements and generate for display the advertisement to the user.

In some aspects, control circuitry may store a time stamp of when the first conversion event occurred, for example, as part of the data structure for the retargeting sequence. Determining the predicted time of occurrence of the second conversion event may include calculating a difference between the time stamp of when the first conversion event occurred and a time stamp stored in the first data structure, of when the user first viewed an advertisement of the first plurality of advertisements, and adding the difference to a time stamp of a first transmission of an advertisement of the first plurality of advertisements during the executing of the retargeting sequence. For example, control circuitry may determine that the first conversion event (e.g., selection of an advertisement on a social network platform) took place at 10 PM, while the first viewed advertisement was viewed at 1 PM using the first platform (e.g., an electronic program guide application). Control circuitry may determine a difference of nine hours, and add this difference to a 12:30 PM start time of a subsequent series of advertisements according to the order of the retargeting sequence.

In some embodiments, control circuitry may increment a first count of a number of times that the user has viewed any advertisement of the first plurality of advertisements in response to determining that the user has viewed the first advertisement. For example, control circuitry may increment a count of a number of times that a user has viewed Lexus car advertisements on a first platform. Control circuitry may determine the retargeting sequence further by setting the first threshold based on the first count. For example, after the first conversion event (e.g., a selection of a Lexus advertisement on a social network platform) has occurred, control circuitry 304 may determine that a count of the number of any of advertisements on the first platform (e.g., a count of the number of video commercial advertisements generated for display through an electronic program guide), is 3, and store the number as a threshold.

Control circuitry may store, as part of the retargeting sequence, the first threshold and a rule to transmit, by way of the second platform, an advertisement selected from the second plurality of advertisements for display to the user in response to determining that an incrementing of the first count caused the first count to exceed the first threshold. For example, control circuitry may store, to a data structure for the retargeting sequence, the first threshold and metadata for first metadata and a rule that upon determining that a count of the number of times that a user has viewed any advertisements correlated to the first metadata using the first platform exceeds the first threshold.

In some embodiments, control circuitry may execute the retargeting sequence by resetting the first count and loading the rule from the retargeting sequence. For example, control circuitry may reset the first count in order to start new iteration of generating for display advertisements using the first platform and the second platform according to a determined retargeting sequence. Control circuitry may load the rule to retarget from the first platform to the second platform in response to determining that a count of advertisements related to first metadata stored in the data structure for the retargeting sequence exceeds the first threshold. Control circuitry may determine that the user has viewed, using the first platform, any advertisement of the first plurality of advertisements, and increment the first count in response to determining that the user has viewed, using the first platform, any advertisement of the first plurality of advertisements. For example, control circuitry may determine that a user has viewed an advertisement related to Lexus cars.

Control circuitry may determine that the first count exceeds the first threshold, and cause the second advertisement to be displayed, by way of the second platform, to the user in response to determining that the first count exceeds the first threshold and in response to loading the rule. For example, control circuitry may determine that a user may determine that a user has viewed Lexus car advertisements four times, which exceeds the first threshold of 3, and based on the loaded rule, determine that the next advertisements should be generated for display on the second platform.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application for selecting media assets in accordance with some embodiments of the disclosure;

FIG. 2 shows an illustrative media guidance application that may be used to adjust user settings in accordance with some embodiments of the disclosure;

FIG. 3 is a block diagram of an illustrative media system in accordance with some embodiments of the disclosure;

FIG. 4 is a block diagram of an illustrative media system in accordance with some embodiments of the disclosure;

FIG. 5 shows an illustrative display that can be generated for display to a user to display media assets and advertisements to a user in accordance with some embodiments of the disclosure;

FIG. 6 shows an illustrative display that can be generated for display to a user to display advertisements through a platform in accordance with some embodiments of the disclosure;

FIG. 7 shows a timing diagram that illustrates a retargeting sequence for displaying advertisements to a user through multiple platforms in accordance with some embodiments of the disclosure;

FIG. 8 shows a timing diagram that illustrates a retargeting sequence for displaying advertisements to a user through multiple platforms in accordance with some embodiments of the disclosure;

FIG. 9 is a flowchart of illustrative steps involved in retargeting advertisements to a user through multiple platforms in accordance with some embodiments of the disclosure; and

FIG. 10 is a flowchart of illustrative steps involved in determining a retargeting sequence for displaying advertisements to a user through multiple platforms in accordance with some embodiments of the disclosure.

### DETAILED DESCRIPTION

Methods and apparatus are disclosed herein for retargeting advertisements from a first platform to a second platform based on determining that a user has viewed advertisements corresponding to first metadata a number of times that exceeds a threshold, and subsequently select a related advertisement for display on a second platform. By using a threshold to determine when to retarget advertisements (e.g., from an electronic program guide platform providing linear content to a social network platform), the retargeting can be performed based on prior viewing habits with advertisements that were used to determine the threshold.

For example, by way of the methods and apparatus disclosed herein, control circuitry of a user equipment device may generate for display on a display screen a first advertisement (e.g., for an electronic chess game) using a first platform (e.g., during a broadcast program on an electronic program guide platform). Control circuitry may increment a count of a number of times that the user has viewed advertisements related to a first set of metadata (e.g., Games->Chess). Control circuitry may determine that the count exceeds a threshold (e.g., 3 times), and in response calculate a plurality of correlation metrics between the first metadata (e.g., Games->Chess), and metadata for a plurality of candidate advertisements (e.g., a correlation metric of 1 for Games->Checkers, and a correlation metric of 2 for Games->Chess). Control circuitry may select the candidate advertisement having the highest correlation metric (e.g., the candidate advertisement corresponding to metadata, Games->Chess). Control circuitry may cause the second advertisement to be generated for display via web page accessed from a second platform (e.g., an e-mail platform). Control circuitry may instead select a candidate advertisement having metadata that is identical to first metadata (e.g., Games->Chess) as the second advertisement, and cause the second advertisement to be generated for display via the web page accessed from the second platform.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

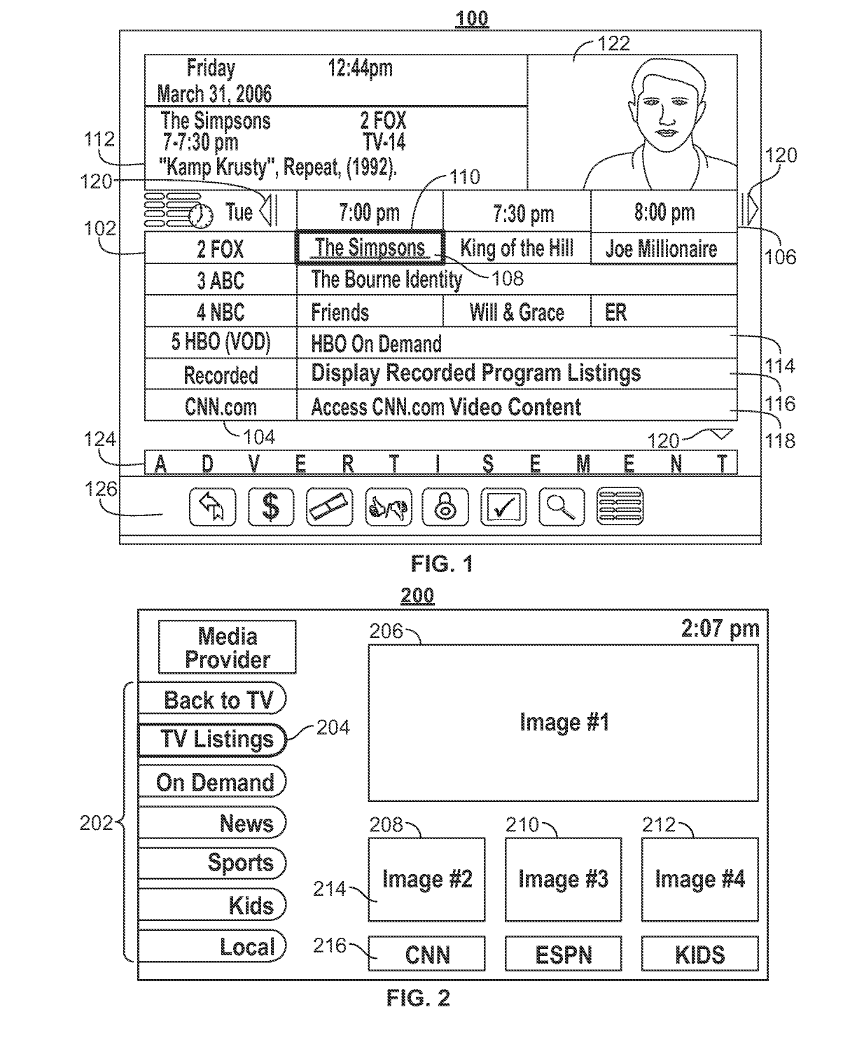

FIGS. 1-2 and 5-6 show illustrative display screens that may be used to provide media guidance data. The display screens shown in FIGS. 1-2 and 5-6 may be implemented on any suitable user equipment device or platform. As referred to herein, the term “platform” should be understood to mean a service that permits advertisers to communicate, transmit, or display advertisements to a user, such as an e-mail platform, social network platform, electronic program guide platform, electronic signboard platform or any other suitable service. For example, the display screens shown in FIGS. 1-2 and 5-6 may correspond to an electronic program guide platform for viewing media assets provided by television broadcasters. While the displays of FIGS. 1-2 and 5-6 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases. Advertisement 124 may be part of a retargeting sequence of a series of advertisements that are displayed on a number of platforms. For example, advertisement 124 may be a first advertisement in the retargeting sequence that is displayed on an electronic program guide platform as illustrated in FIGS. 1-2, followed by subsequent related advertisements that are displayed on another platform such as a social network platform, or e-mail platform. As referred to herein, the term “retargeting sequence” should be understood to mean an order or sequence in which related advertisements are displayed to a user through different platforms in order to effect a conversion event by the user. The retargeting sequence may reflect a series of display of advertisements that is effective in causing the conversion event based on past viewing behavior of the user. As referred to herein, the term “conversion event” should be understood to mean occurrence of a target activity executed by a user that was directed by advertisements (e.g., scheduling of a recording, subscription to a service, etc).

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on). In some embodiments, listings 206, 208, 210 and 212 may instead be selectable advertisements, similar to advertisement 124 illustrated in FIG. 1. Listings 206, 208, 210 and 212 may be part of a retargeting sequence of related advertisements.

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

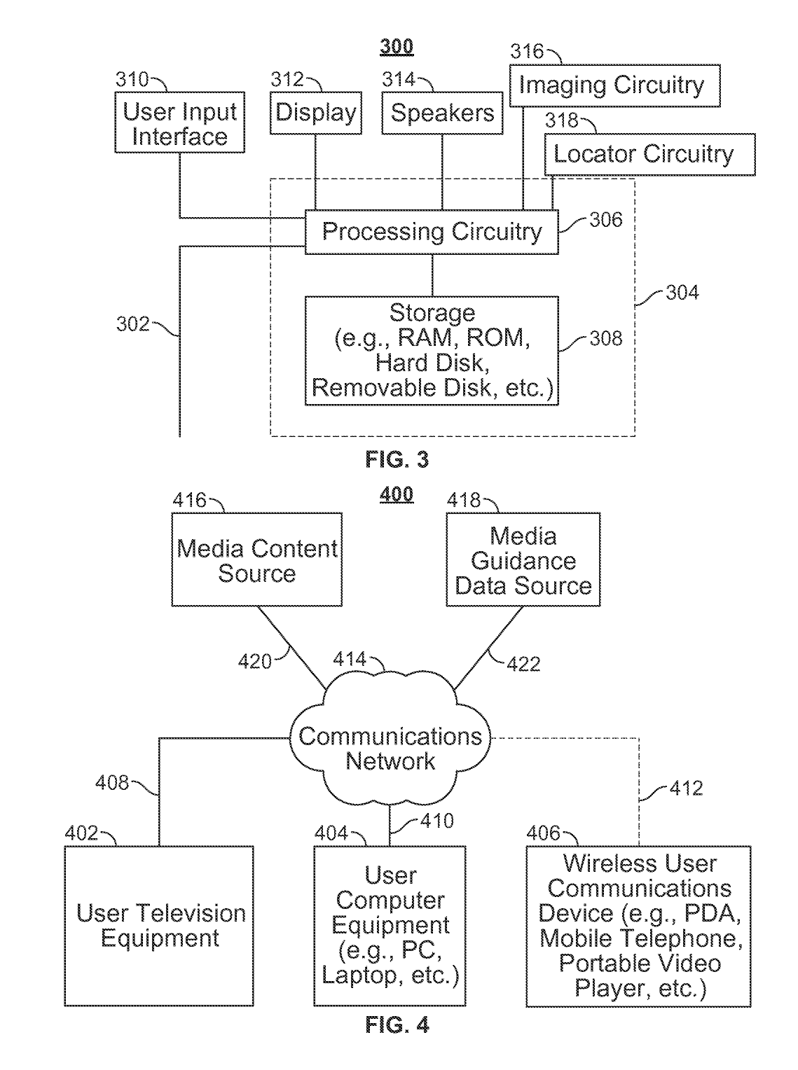

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing. Imaging circuitry 316 may be used to capture video or still images that are provided to control circuitry 304. Locator circuitry may be used to determine a location of user equipment 300.

Imaging circuitry 316 may include a camera, infrared imaging device, or any other suitable imaging device. Control circuitry 304 may process video or images received from imaging circuitry 316 to determine an attentiveness level of a user, for example, by performing facial recognition on a user, identifying the eyes of the user, and determining that the eyes of a viewer are viewing display 312 for at least a minimum period of time. As referred to herein, the term “attentiveness level” should be understood to mean a measurement of user attentiveness to a displayed item, based on duration, dilation of pupils, or any other suitable metric for determining attentiveness.

Locator circuitry 318 may include a GPS antenna, cellular antenna, or any other suitable device for receiving signals indicative of a location of a user equipment device. Locator circuitry may be coupled with control circuitry 304 in order to determine a location of the user equipment device. For example, control circuitry 304 may determine map coordinates of a user based on GPS coordinates, triangulation with cellular towards, or general location based on, an IP address.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

Imaging circuitry 316 may include a camera, infrared imaging device, or any other suitable imaging device. Control circuitry 304 may process video or images received from imaging circuitry 316 to determine an attentiveness level of a user, for example, by performing facial recognition on a user, identifying the eyes of the user, and determining that the eyes of a viewer are viewing display 312 for at least a minimum period of time. As referred to herein, the term “attentiveness level” should be understood to mean a measurement of user attentiveness to a displayed item, based on duration, dilation of pupils, or any other suitable metric for determining attentiveness.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406. A user equipment device as described above in reference to FIG. 3 and FIG. 4 may be used to access any of a plurality of platforms such as an electronic program guide platform, an e-mail platform, a social network platform or any other suitable platform. Each user may have multiple user equipment corresponding to that user, where the user may be identified through a user identifier such as a user identification string, a profile identification string, an e-mail address, a phone number, or any other suitable identifier. An identifier of a user device such as a serial number, an IMEI number, a MAC address, an IP address or information contained in a cookie, may be used to identify a user of a user equipment device if there is only one user of the user equipment device. If a user equipment device is shared among multiple users, a user identifier, an identifier of a user equipment device, or any combination thereof may be used to identifier a user.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

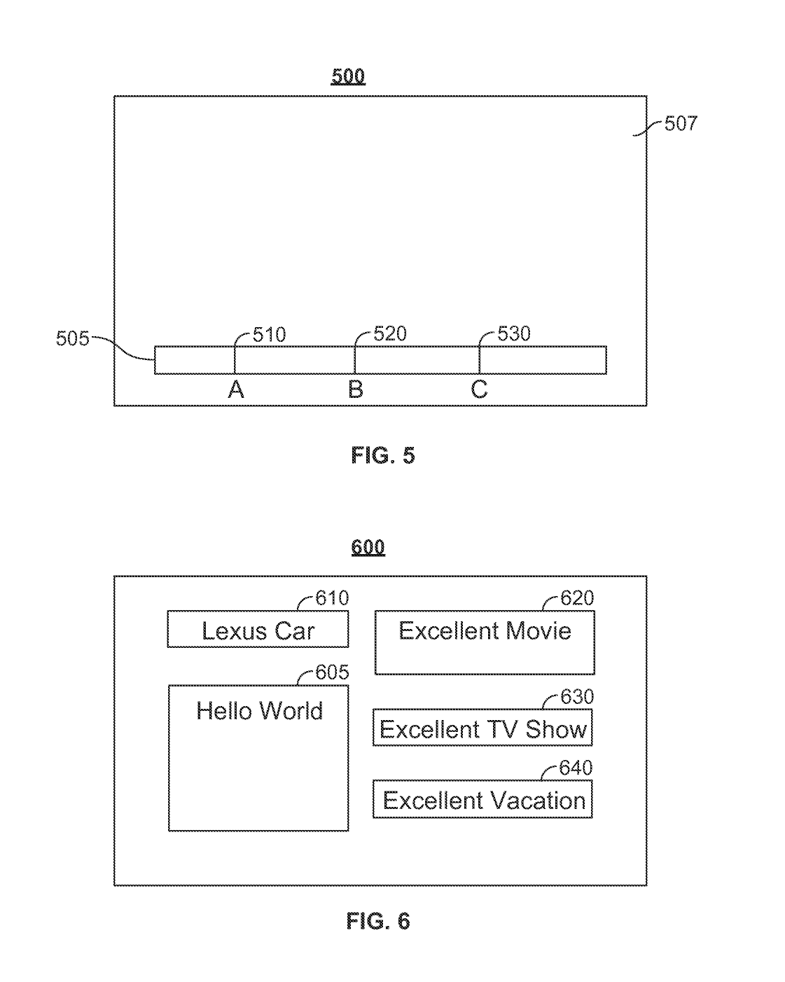

FIG. 5 shows an illustrative display 500 that can be generated for display (e.g., by control circuitry 304) to a user to display media assets and advertisements to a user in accordance with some embodiments of the disclosure. Display 500 may be generated for display on a user equipment (e.g., user equipment 402, 404, and/or 406). FIG. 5 may include a video 507, time bar 505, and time points 510, 520, and 530. Video 507 may correspond to a media asset such as linear programming (e.g., a currently broadcast program), or non-linear programming (e.g., an on-demand program or locally recorded program). Time points 510, 520 and 530 may correspond to times that control circuitry 304 of a user equipment device generates for display video of an advertisement, in between display of video of a media asset. Control circuitry 304 may generate for display or remove from display time bar 505. Each of the advertisements may be the same or related, for example, by a set of metadata. As referred to here, the term “metadata” should be understood to mean a set of one or more fields that describes a media asset, advertisement, web page, other media, or event. The set of fields may include one or more hierarchies that are stored in binary, stored as plain text, or stored in any other suitable format.

FIG. 6 shows an illustrative display 600 that can be generated for display (e.g., by control circuitry 304) to a user to display advertisements through a platform (e.g., a social networking platform, an e-mail platform, etc.) in accordance with some embodiments of the disclosure. Display 600 may be generated on a user equipment device (e.g., user equipment 402, 404, and/or 406). FIG. 6 may include window 605, and advertisements 610, 620, 630 and 640. Window 605 may include information about a service, product, media, or any other information of interest. For example, if display 600 corresponds to a social network platform, window 605 may include information about a user's profile as displayed on a social network. For example, if display 600 corresponds to an e-mail service, window 605 may include information about e-mails accessed by a user. Advertisements 610, 620, 630 and 640 may be similar to any of advertisements 124 illustrated in FIG. 1, or advertisements/listings 206, 208, 219, and 212 illustrated in FIG. 2. While display 200 of FIG. 2 may correspond to an electronic program guide application platform, display 600 of FIG. 6 may correspond to a platform (e.g., accessed through a web page or application) other than the electronic program guide application. Any of advertisements 610, 620, 630 and 640 may correspond to any of the advertisements presented at time points 510, 520 and 530 as shown in FIG. 5. Advertisements 610, 620, 630 and 640 may be displayed as part of a retargeting sequence with one or more of the advertisements displayed at time points 510, 520 and 530.

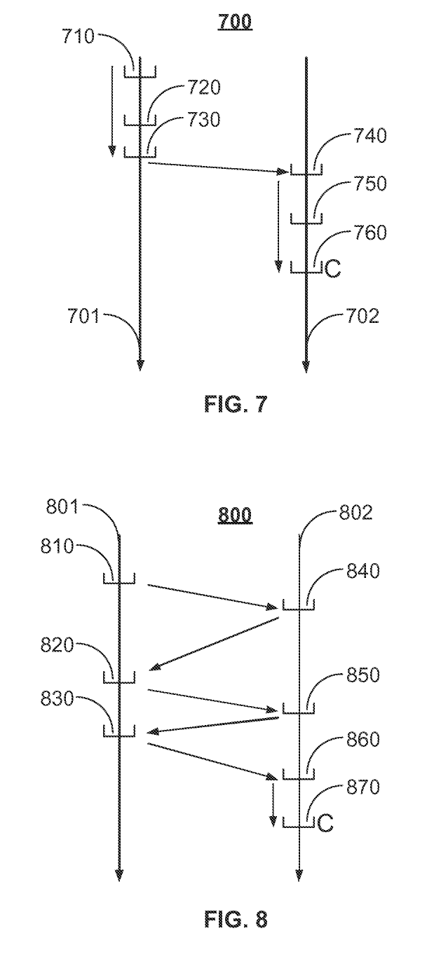

FIG. 7 shows a timing diagram 700 that illustrates a retargeting sequence for displaying advertisements to a user through multiple platforms in accordance with some embodiments of the disclosure. Timing diagram 700 includes a first timeline 701 corresponding to a first platform (e.g., an electronic program guide application platform), and a second timeline 702 corresponding to a second platform (e.g., a social network). Points 710, 720, and 730 along timeline 701 and points 740, 750 and 760 along timeline 702 may correspond to times when advertisements are generated for display (e.g., by control circuitry 304 of a user equipment device) to a user, and/or may correspond to times when displayed advertisements are viewed by a user. For example, control circuitry 304 may receive image information from imaging circuitry 316 and determine whether a user has sufficient interest in viewing an advertisement to determine a time when an advertisement is viewed by a user. As referred to herein, the term “sufficient interest” should be understood to be a measure of user interest that exceeds a threshold. The measure of user interest may be determined based on amount of time that a user's face and/or eyes are determined to be facing a display device on which an advertisement or media asset is displayed, or the number of times (e.g., frequency) with which a user turned away from the display, or a measure of the dilation of a user's pupils.

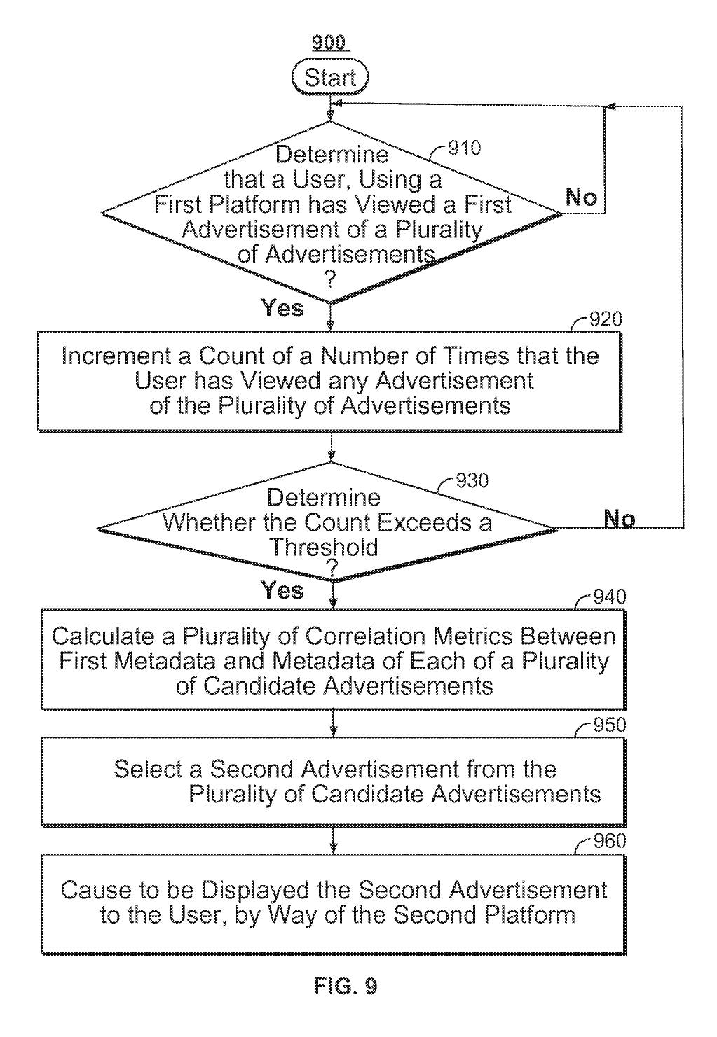

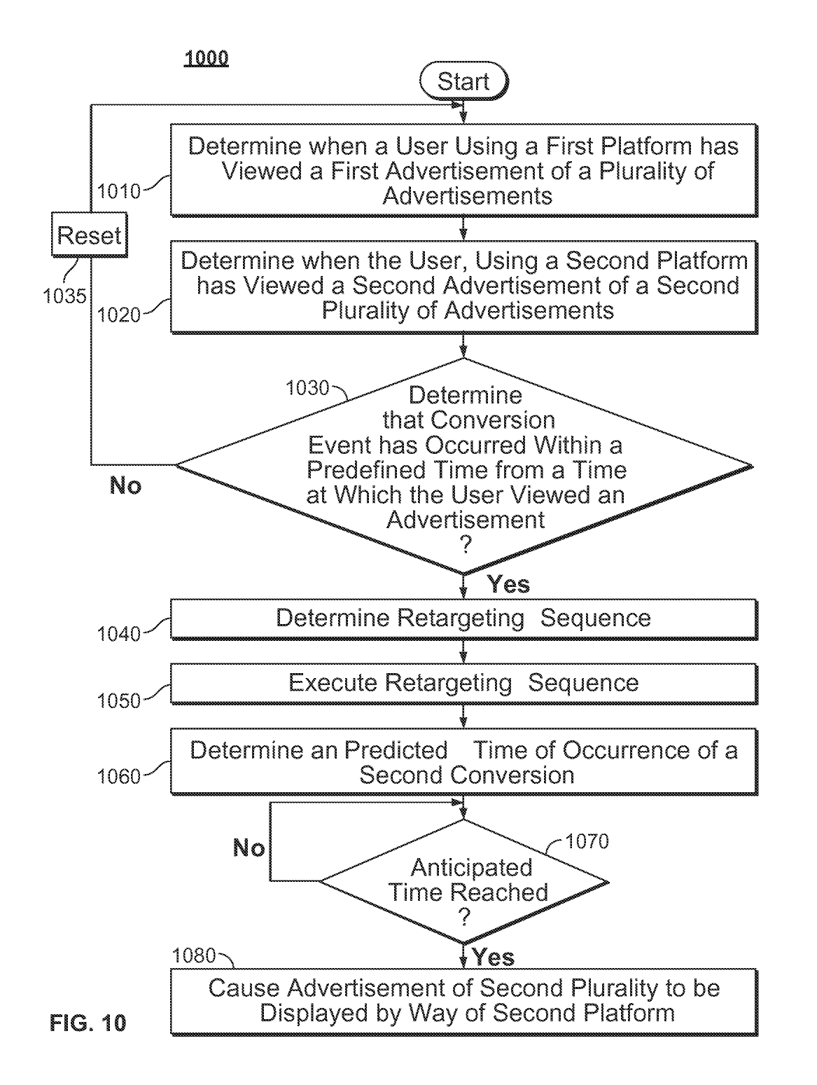

Timing diagram 700 may illustrate a retargeting sequence composed of a first series of displays of advertisements on the first platform (e.g., as represented by advertisements displayed at time points 710, 720, and 730 on timeline 701), followed by a second series of displays of advertisements on the second platform (e.g., as represented by advertisements displayed at time points 740, 750 and 760 on timeline 702). Advertisements displayed at 710, 720 and 730 may be related by first metadata, as discussed further below in reference to FIG. 9. For example, a first advertisement generated for display at time point 710 (e.g., by control circuitry 304 of a user equipment device of FIG. 3) may include the met adata (Car->Sedan->Lexus->[Year2015,IS350]; VideoAd). The example metadata may include subsets (e.g., [Year2015,IS350] describing a year and model), and may delimit sets of information (e.g., through the use of the “;” character). A second advertisement generated for display at time point 720 (e.g., by control circuitry 304 of a user equipment device of FIG. 3) may include the metadata (Car->SUV->Lexus->[Year2015,LX570]; VideoAd). A third advertisement generated for display at time point 730 (e.g., by control circuitry 304 of a user equipment device of FIG. 3) may include the metadata (Car->Sedan->[Year2014,LS460]; VideoAd). All three of the advertisements are related by the metadata fields, Car and Lexus, which may be the first metadata. Control circuitry 304 may determine a correlation metric between the metadata of the three fields by determining a number of intersecting metadata fields among the advertisements. For example, control circuitry may determine that all three advertisements have a correlation metric of 3, because of the intersecting fields of “Car”, “Lexus” and “VideoAd”. As referred to herein, the term “correlation metric” should be understood to be a measure of relatedness between two items based on characteristics such as metadata. A correlation metric can be calculated between any plurality of metadata (e.g., between two or more metadata items).

Control circuitry may determine that the first advertisement and the second advertisement have 4 intersecting fields (“Car”, “Lexus”, “Year2015”, and “VideoAd”), may determine that the second advertisement and the third advertisement may have 3 intersecting fields (“Car”, “Lexus”, “VideoAd”), and may determine that the first advertisement and the third advertisement have 4 intersecting fields (“Car”, “Sedan”, “Lexus”, “VideoAd”). In some aspects, the control circuitry may determine a correlation metric by determining the number of intersecting fields. For example, control circuitry may determine that a correlation metric between the first and second advertisement is 4, that a correlation metric between the second and third advertisements is 3, and that a correlation metric between the first and third advertisements is 4.

In some aspects, control circuitry may determine a correlation metric by computing a weighted sum of the number of intersecting fields, where the weight is determined based on a position in a hierarchy. For example, a metadata field in the first position is given a weight of 4, a metadata field in the second position is given a weight of 3, a metadata field in the third position is given a weight of 2, and a metadata field in the fourth position is given a weight of 1. In the case of a subset, the weight may be partitioned equally among the elements of the subset (e.g., in [Year2015, IS350], both the year and model are given equal weight or half the weight assigned to the position in the hierarchy, or apportioned based on position within the subset such as year receiving a weight of 0.75 and the make receiving a weight of 0.25). In some embodiments, correlation metric may be based on a weighting of the metadata fields based on position of the metadata fields within the hierarchy. Control circuitry may determine, using these weights, that a correlation between the first and second advertisements is 6.5 (e.g., 4*1+3*0+2*1+(0.5*1+0.5*0)+1*1). Control circuitry may determine, using these weights, that a correlation metric between the second and third advertisements is 6 (e.g., 4*1+3*0+2*1+(0.5*0+0.5*0)+1*1). Control circuitry may determine that a correlation metric between the first and third advertisements is 9 (e.g., 4*1+3*1+2*1+(0.5*1+0.5*0)+1*1). In the case of this weighted method of determining a correlation metric, the first and third advertisements have a higher correlation metric than the first and second advertisements because of the significance of the weighting on the second metadata field “Car”.

Advertisements displayed at 740, 750 and 760 may be related by second metadata, as discussed further below in reference to FIG. 9. For example, advertisements displayed at 740, 750, and 760 may all share the common metadata fields (“Car”, “Lexus”, “Dealership” and “TestDrive”), which may be the second metadata. The first metadata and the second metadata may be related as discussed further below in reference to FIG. 9. For example, the first metadata and the second metadata have the intersecting metadata fields (“Car” and “Lexus”).

Control circuitry 304 of a server or a user equipment device (e.g., any of user equipment 402, 404 and/or 406) may generate for display a series of advertisements on the first platform and the second platform based on the retargeting sequence. Control circuitry 304 may receive an indication from an advertising sponsor to initiate a retargeting sequence. For example, control circuitry 304 may receive an order to initiate a retargeting sequence for a product on one or more users. Control circuitry 304 may load a retargeting sequence for a user from storage 308 based on a user identifier for the user (e.g., an e-mail address). For example, a plurality of retargeting sequences may be stored in a database in storage 308, indexed by user identifiers. Control circuitry 304 may issue a query command with a user identifier (e.g., an e-mail address) to the database in storage 308 to retrieving a retargeting sequence for a respective user. In some aspects, control circuitry 304 may issue a query command that includes metadata for a product indicated by the advertising sponsor (e.g., “Car”; “Lexus”). In response to issuing the query command, including the user identifier and/or metadata for the product, control circuitry receives a retargeting sequence or pointer to the retargeting sequence as a query result from the database.

As discussed below in reference to FIGS. 9 and 10, control circuitry 304 may load the retargeting sequence from storage 308 and execute the retargeting sequence. In some embodiments, the retargeting sequence may be a data structure that includes an ordered list of records, where each record includes a time stamp (e.g., indicating a time of day on a 24-hour cycle, a day of a week, a week of a year, a month of a year, or any combination thereof), metadata for selecting an advertisement, an identifier of a platform, and an identifier of the data structure. The data structure may also include a threshold for transitioning from a first platform to a second platform, and/or a rule describing a transition from a first platform to a second platform. The data structure may also include a score for the retargeting sequence used to select among multiple retargeting sequences that can meet a same query. For example, in reference to timing diagram 700 of FIG. 7, control circuitry may load a data structure that includes six records, each corresponding to one of time points 710, 720, 730, 740, 750, and 760 of timing diagram 700 of FIG. 7. In some aspects, the time stamp of each record may indicate a time of day during which an advertisement may be generated for display.

Control circuitry may retrieve a first record corresponding to time point 710 from the ordered list of records included in the data structure. Control circuitry may identify a first time to generate for display a first advertisement based on a time stamp included in the first record. Control circuitry 304 may select an advertisement from an advertisement database (e.g., media content source 416 or media guidance data source 418 or any other suitable source or server) by issuing a query command that includes the first metadata (e.g., “Car”, “Lexus”) and identifier of a platform (e.g., an electronic program guide application platform) to the advertisement database. In some aspects, a separate advertisement database may be maintained for each platform, and control circuitry may select an advertisement database based on an identifier of the platform, and issue a query command to the database that includes the first metadata. In response, control circuitry may receive a first advertisement (e.g., a video advertisement that corresponds to the metadata Car->Sedan->Lexus->[Year2015,IS350]; VideoAd) or pointer to a first advertisement. Control circuitry may schedule a time that the first advertisement is generated for display to the user. For example, control circuitry 304 may transmit the first advertisement to a user television equipment 402 (or any suitable user equipment device) with instructions to generate the advertisement for display at the time stamp corresponding to time point 710.

Control circuitry 304 may determine whether the first advertisement has been viewed by the user. For example, control circuitry 304 may receive an indication that the first advertisement has been viewed by the user of the user television equipment 402 (e.g., based on a determination that the user has viewed the advertisement for longer than a minimum time). In response to determining that the user has viewed the first advertisement, control circuitry may continue executing the retargeting sequence, restart the retargeting sequence (e.g., on a subsequent day, week, month, etc.), or abort the retargeting sequence.

In response to determining that the user has viewed the first advertisement, control circuitry may retrieve a second record corresponding to time point 720 from the ordered list of records included in the data structure. Control circuitry may identify a second time to generate for display a second advertisement based on the time stamp included in the second record. Control circuitry may select an advertisement from the advertisement database by issuing a query command that includes the first metadata (e.g., “Car”, “Lexus”) and an identifier of the platform included in the second record. Control circuitry may receive a second advertisement (e.g., a video advertisement corresponding to the metadata (Car->SUV->Lexus->[Year2015,LX570]; VideoAd). Control circuitry may schedule a generation for display (e.g., on the electronic program guide application platform) of the second advertisement at the time stamp corresponding to time point 720 included in the second record. Control circuitry may determine whether user has viewed the second advertisement and, in response, continue with the retargeting sequence, reschedule the retargeting sequence or abort the retargeting sequence.

Control circuitry may continue the process of executing the retargeting sequence by retrieving successive records from the data structure of the retargeting sequence, selecting advertisements based on metadata included in each record an identifier of a platform included in each record. For example, control circuitry may retrieve a fourth record corresponding to time point 740 that includes second metadata (e.g., including metadata fields “Car”, “Lexus”, “Dealership” and “TestDrive”) instead of the first metadata and retrieve an indicator of the second platform (e.g., a social network platform) instead of an indicator of the first platform. The correspondence of the fourth record to time point 740 is illustrated in timing diagram 700 where time point 740 indicates display of an advertisement using the second platform instead of the first platform, as indicated by position of time point 740 on timeline 702. Control circuitry may retrieve a fourth advertisement (e.g., a selectable graphical advertisement for a test drive at a dealer located at Address1, where the advertisement includes metadata “Car->SUV->Lexus->Testdrive; Dealership->Address1”) corresponding to time point 740 by issuing a query to an advertisement that includes second metadata (e.g., including metadata fields “Car”, “Lexus”, “Dealership” and “TestDrive”) and the indicator of the second platform (e.g. a social network platform). Control circuitry may then schedule generation for display of the fourth advertisement at a time stamp corresponding to time point 740 on the second platform (e.g., a social network platform), by transmitting the advertisement to the second platform with an indication of the time stamp corresponding to time point 740. The second platform may then relay the fourth advertisement to a user equipment device of the user at the scheduled time (e.g., for generation for display in a webpage or an application).

Control circuitry may proceed with the scheduling of the fifth and sixth advertisements corresponding to time points 750 and 760 and determine whether a conversion event has occurred. For example, control circuitry may determine whether a conversion event (e.g., presence of a user proximate or at an address of a dealership indicated in a test drive offer, selection of the selectable graphical advertisement, etc.) has occurred within a predefined period from a time at which the user viewed the last advertisement in the retargeting sequence (e.g., a sixth advertisement corresponding to time point 760). In response to determining that a conversion event has occurred, control circuitry may increment the score in the data structure of the retargeting sequence, and issue an update command (e.g., containing the identifier of the data structure containing the retargeting sequence) to the database containing the plurality of retargeting sequences in storage 308, to update the data structure for the received targeting sequence to update its score, to increase the likelihood that it will be subsequently selected. In response to determining that a conversion event has not occurred within the predefined period, control circuitry may reschedule an execution of the retargeting sequence and decrement the score in the data structure of the retargeting sequence and issue an update command to the database to decrement the score.

In some embodiments, control circuitry 304 may determine a retargeting sequence for execution based on tracking a series of user interactions with advertisements (e.g., for related metadata such as metadata for a product, upcoming event, or other item for advertisement). In some aspects, control circuitry may initiate tracking of a category of advertisements (e.g., related advertisements that might lead to a subscription of a service or viewing of a new television series) based on requests received from sponsors of advertisements. For example, control circuitry may receive a request by a media programming network to track advertisements that may lead to a conversion event for a new program series.

Control circuitry 304 may determine that a first plurality of advertisements (e.g., for a new series “DoveLand”) that are related by first metadata (e.g., the metadata “Media->Series->Title->DoveLand; NewPremier; GraphicalAd”) have been generated for display to a user or viewed by the user on a first platform (e.g., an e-mail platform). The advertisements may be generated for display at random times, or based on prior viewing times from other retargeting sequences stored in a database. Control circuitry 304 may store within a list a record for each time that the advertisement was generated for display, where each record includes a time stamp (e.g., indicating a time of day on a 24-hour cycle, a day of a week, a week of a year, a month of a year, or any combination thereof) of when the advertisement was displayed, metadata for the displayed advertisement, an identifier of a platform on which the advertisement was generated for displayed or viewed (e.g., an e-mail platform), and an identifier of the user. For example, control circuitry 304 may store three records corresponding to time points 710, 720 and 730 indicating that an advertisement related to the first metadata has been generated for display or viewed on the first platform corresponding to timeline 701.

In some aspects, control circuitry may store the record in response to determining that the advertisement has been viewed by the viewer. For example, control circuitry may receive an indication through the first platform (e.g., the e-mail platform), that the advertisement was generated for display for a predetermined period of time on a user equipment device (e.g., any of 402, 404, or 406). For example, control circuitry may receive an indication (via the first platform) that a user of a user equipment device accessing the first platform (e.g., through a webpage or an application) on a user equipment device (e.g., a smartphone) has viewed the advertisement for a predetermined period of time based on information processed by control circuitry of the user equipment device from imaging circuitry 316 of the user equipment device.

Control circuitry may determine that a second plurality of advertisements (e.g., for the new series “DoveLand”) that are related by second metadata have been generated for display to the user or viewed by the user on a second platform (e.g., an electronic program guide application platform). For example, the second metadata may include the metadata fields: “Media->Series->Title->DoveLand; NewPremier; VideoAd”. Control circuitry 304 may generate for display a video advertisement commercial for display through a second platform (e.g., an electronic program guide application platform) to promote the new series “DoveLand”, which will premier on a certain date. The advertisement may correspond to metadata (“Media->Series->Title->DoveLand; NewPremier->PremierDate; VideoAd”). Control circuitry 304 may store within the list a record for each time that the advertisement was generated for display, where each record includes a time stamp (e.g., indicating a time of day on a 24-hour cycle, a day of a week, a week of a year, a month of a year, or any combination thereof) of when the advertisement was displayed, metadata for the displayed advertisement, an identifier of a platform on which the advertisement was generated for displayed or viewed (e.g., an electronic program guide platform), and an identifier of the user. For example, control circuitry may store three records corresponding to time points 740, 750 and 760.

Control circuitry may determine whether a conversion event has occurred within a predefined period from when a last advertisement has been generated for display or viewed (e.g., an advertisement at time point 760). For example, control circuitry may determine whether a conversion event (e.g., scheduling of a recording for the premier of the new series “DoveBar”) has occurred within a predefined period from a time at which the user viewed the last advertisement in a series of display of advertisements (e.g., the video advertisement corresponding to time point 760). In response to determining that a conversion event has occurred, control circuitry may issue a create command to the database including the plurality of retargeting sequences to create a data structure for a retargeting sequence that includes the list of records of advertisements that were for display to the user on the first and second platforms, and an identifier of the user.

Control circuitry may subsequently execute the retargeting sequence, for example, in response to receiving a request from an advertisement sponsor to promote an item that corresponds to the first metadata and second metadata of the advertisements stored in a list of the records in the retargeting sequence. For example, control circuitry may determine a first retargeting sequence for a user to purchase a soft drink. Control circuitry may subsequently receive a request from the same advertisement sponsor for the soft drink, or different advertisement sponsor for a product related to a soft drink, such as paper towels. Control circuitry may select the first retargeting sequence used for the soft drink, and execute the first retargeting sequence for the paper towels. In some embodiments, control circuitry may select the first retargeting sequence based on overlapping metadata between the soft drink and the paper towels (e.g., “Use->Party”). For example, both the soft drink and paper towels product may include the same metadata lookup field, and control circuitry may receive the same first retargeting sequence in response to a query including the overlapping metadata issued to a database of retargeting sequences.

In some embodiments, control circuitry may first determine related products and services by issuing a query command to a database that includes a selection of metadata information from a higher level of a hierarchy. For example, metadata for the soft drink may include the fields: “Product->SoftDrink; Use->Party->Refreshment”. Control circuitry may first create a data structure in the database for the first retargeting sequence for the soft drink that is indexed based on “Use->Party->Refreshment”. When receiving a request to promote paper towels, control circuitry may receive metadata for the paper towels: “Product->PaperTowel; Use->Party->Utensil”. Control circuitry may issue a query command to the database that includes the two higher level fields “Use->Party” and retrieve the first retargeting sequence that was created based on the soft drink. Control circuitry may subsequently execute the first retargeting sequence for advertisements correlated to the “Product->PaperTowel; Use->Party->Utensil” metadata.

In some embodiments, the first platform and the second platform are accessed using a same user equipment device (e.g., any of user equipment devices 402, 404 and 406). The timing diagram may illustrate a retargeting sequence that is used by a system to display advertisements to a user, in order to cause the user to perform a conversion event. Time points 710, 720, and 730 may correspond to time points 510, 520 and 530 as shown in FIG. 5. For example, the user equipment device may be user television equipment 402, and each of time points 710, 720 and 730 may be described by time stamps. At time point 710, control circuitry 304 of the user television equipment may select and generate for display a first advertisement (e.g., about a Lexus car based on the first metadata “Car” and “Lexus”) via display 500 at time point 510 to a user. At time point 720, control circuitry 304 of the user television equipment may generate for display a second advertisement (e.g., about the same Lexus car also based on the first metadata “Car” and “Lexus”) via display 500 at time point 520 to the user. At time point 730, control circuitry 304 of the user television equipment may generate for display a third advertisement (e.g., about a different Lexus car also based on the first metadata “Car” and “Lexus”) via display 500 at time point 530 to the user.

Time points 710, 720, and 730 may correspond to a combination of time points 510, 520 and 530, and time points at which control circuitry 304 generates for display advertisements in display 100 of FIG. 1 (e.g., advertisement 124) or display 200 of FIG. 2 (e.g., advertisements 206, 208, 210, and 212). For example, at time point 710, control circuitry 304 of the user television equipment may generate for display, in display 500 of FIG. 5, a first advertisement at time point 520. At time point 720, control circuitry 304 of the user television equipment may generate for display, in display 100 of FIG. 1, a second advertisement as advertisement 124. At time point 730, control circuitry 304 of the user television equipment may generate for display, in display 200 of FIG. 2, a third advertisement as any of advertisements 206, 208, 210, or 212.

Time points 740, 750, and 760 may correspond to times when advertisements are generated for display (e.g., by control circuitry 304) to a user using a second platform (e.g., a social network) different than the electronic program guide platform, via display 600 of FIG. 6. Time point 760 may also correspond to the display of an advertisement at which, or after which a conversion event occurs. For example, at time point 740, control circuitry 304 generates for display an advertisement 610 (e.g., about a test drive offer for a Lexus car based on second metadata includes “Car”, “Lexus”, “Dealership” and “TestDrive”) to a user. At time point 750, control circuitry 304 generates for display via display 600 of FIG. 6 an advertisement 610 (e.g., about a Lexus showroom at a dealership based on second metadata includes “Car”, “Lexus”, “Dealership” and “TestDrive”). At time point 760, control circuitry 304 generates for display via display 600 of FIG. 6 an advertisement 610 (e.g., about a Lexus dealership based on second metadata includes “Car”, “Lexus”, “Dealership” and “TestDrive”). At time point 760, or within a predefined period of time point 760, a control circuitry 304 may detect a conversion event executed by a user. For example, control circuitry 304 may determine that a user has selected advertisement 610 by receiving a user selection of the advertisement, or has visited a Lexus dealership (e.g., control circuitry may determine, using location circuitry 318 that a user is located within the Lexus dealership for greater than a minimum period of time).

In some embodiments, the retargeting sequence, that is used to display advertisements to a user, may specify a location within a display at which an advertisement should be displayed. For example, a second platform corresponding to timeline 702 may be an e-mail platform. At time point 740, control circuitry 304 may generate for display a first advertisement at location 620. At time point 750, control circuitry 304 may generate for display a second advertisement at location 630. At time point 760, control circuitry 304 may generate for display a third advertisement at location 640.

In some embodiments, the retargeting sequence may be determined by determining times at which a user has viewed advertisements on a first platform corresponding to timeline 701 or a second platform corresponding to timeline 702. For example, the first platform may be an electronic program guide application, and the second platform may be a social network, accessed from a user television equipment. At time point 710, control circuitry 304 of the user television equipment may determine that a user has viewed a first advertisement (e.g., a Lexus commercial displayed in display 500 at time point 510 where the Lexus commercial includes first metadata “Car” and “Lexus”) by determining that the user television equipment continues to access a same source (e.g., a channel) for displaying the first advertisement. In response to this determination, control circuitry 304 may store a first record including a time stamp corresponding to time point 710, an identifier of the first advertisement, and an identifier of the first platform to the retargeting sequence. At time point 720, control circuitry 304 of the user television equipment may determine that the user has viewed a second advertisement (e.g., a Lexus commercial displayed in display 500 at time point 510 where the Lexus commercial includes first metadata “Car” and “Lexus”), and in response control circuitry 304 may store a second record including a time stamp corresponding to time point 720, an identifier of the second advertisement, and an identifier of the first platform. At time point 730, control circuitry 304 may determine that a user has viewed a third advertisement (e.g., a Lexus banner advertisement displayed as advertisement 124 in FIG. 1 where the Lexus commercial includes first metadata “Car” and “Lexus”), and in response store a third record including a time stamp corresponding to time point 730, an identifier of the third advertisement, and an identifier of the first platform.

At time point 740, control circuitry 304 of the user equipment may determine that the user has accessed a social network platform, instead of the electronic program guide application platform. Control circuitry 304 may determine that a user has viewed a fourth advertisement (e.g., an advertisement for a Lexus car displayed as advertisement 610 in display 600 of the social network platform), and in response store a fourth record including a time stamp corresponding to step 740, an identifier of the fourth advertisement, and an identifier of the second platform. At time point 750, control circuitry 304 may determine that a user has viewed a fourth advertisement (e.g., an advertisement for a Lexus car displayed as advertisement 610 in display 600 of the social network platform), and in response store a fifth record including a time stamp corresponding to step 750, an identifier of the fifth advertisement, and an identifier of the second platform. At time point 760, control circuitry 304 may determine that a user has viewed a sixth advertisement (e.g., an advertisement for a Lexus car displayed as advertisement 610 in display 600 of the social network platform), and in response store a sixth record including a time stamp corresponding to step 760, an identifier of the sixth advertisement, and an identifier of the second platform.

In some embodiments, the first platform is accessed using a first user equipment device and the second platform is accessed using a second user equipment device. For example, while watching a television broadcast on user television equipment 402 through an electronic program guide (e.g., a first platform), a user may be presented with a first series of advertisements related to a product (e.g., at time points 510, 520 and 530 as illustrated in FIG. 5), and subsequently access an e-mail service (e.g., a second platform) on a user computer equipment 404 (e.g., a laptop). When accessing the e-mail service, the user may be presented with a second series of advertisements that are related to the first series of advertisements and to the same product. According to retargeting sequence 700 illustrated in FIG. 7, the user may not be presented with the series of advertisements when accessing the e-mail service initially, as the retargeting sequence indicates that a series of advertisements on an electronic program guide application platform followed by a series of advertisements on an e-mail platform are more effective in promoting a product to a user.

Control circuitry 304 may generate for display advertisements to a user on user television equipment 402. After control circuitry 304 of the user television equipment 402 has generated for display related advertisements at time points 710, 720 and 730, control circuitry 304 of a user computer equipment 404 (e.g., a Laptop) that is different from the user television equipment may identify that the user of the user computer equipment 404 is the same user of the user television equipment 402. Control circuitry 304 of the user computer equipment 404 may generate for display advertisements at time points 740, 750 and 760 using the second platform.

FIG. 8 shows a timing diagram 800 that illustrates a retargeting sequence for displaying advertisements to a user through multiple platforms in accordance with some embodiments of the disclosure. Timing diagram 800 includes a first timeline 801 corresponding to a first platform (e.g., an e-mail service platform), and a second timeline 802 corresponding to a second platform (e.g., a social network). Points 810, 820, and 830 along timeline 801 and points 840, 850 and 860 along timeline 802 may correspond to times when advertisements are generated for display (e.g., by control circuitry 304) of a user equipment device for display to a user, and/or correspond to times when displayed advertisements are viewed by a user. Advertisements displayed at 810, 820 and 830 may be related by first metadata, as discussed further below in reference to FIG. 9. Advertisements displayed at 840, 850 and 860 may be related by second metadata, as discussed further below in reference to FIG. 9. The first metadata and the second metadata may be related as discussed further below in reference to FIG. 9.

While the retargeting sequence shown in timing diagram 700 illustrated two consecutive series of displays of advertisements (a first series on a first platform followed by a second series on a second platform), timing diagram 800 illustrates a retargeting sequence that interleaves among the first and second platform. For example, timing diagram 800 may describe a sequence of displaying advertisements to a same user that alternately accesses a first platform using a first user device, and a second platform using a second user device. At time point 810, control circuitry 304 of a first user equipment device generates for display, using a first platform (e.g., an e-mail service), a first advertisement (e.g., an advertisement for a theatre movie as advertisement 620 of display 600 of FIG. 6). At time point 820, control circuitry 304 of a second user equipment device may generate for display, using a second platform (e.g., a social network), a second advertisement for the same theatre movie. Control circuitry 304 of the first user equipment device subsequently generates for display, using the first platform, advertisements related to the same movie at time points 820 and 830, interleaved with control circuitry 304 of the second user equipment device generating for display, using the second platform, advertisements also related to the same movie. At or within a predefined period from time point 760, control circuitry 304 may determine that a conversion event (e.g., a user purchase of a movie ticket for the upcoming movie) has occurred.

It should be understood that, while the aforementioned example for timing diagram 800 was discussed in reference to accessing a first platform using a first user equipment device and accessing a second platform using a second user equipment device, the interleaved retargeting sequence 800 may apply to accessing the first platform and the second platform on the same user equipment device.

Although FIG. 7 and FIG. 8 illustrate two platforms, it should be understood that the embodiments described in reference to FIG. 7 and FIG. 8 may apply to any number of platforms (e.g., N number of platforms), and that a retargeting sequence may traverse any number of said platforms. For example, in a case of four platforms, the retargeting sequence may traverse from displaying advertisements on a first platform, to displaying advertisements on a third platform, to displaying advertisements on a second platform, and to displaying advertisements on a fourth platform. The retargeting sequence may also traverse from displaying advertisements on a first platform, to displaying advertisements on a third platform, and to displaying advertisement back on the first platform in order to most effectively cause a conversion event from a user.

FIG. 9 is a flowchart 900 of illustrative steps involved in retargeting advertisements to a user through multiple platforms in accordance with some embodiments of the disclosure. It should be noted that process 900 or any step thereof could be performed on, or provided by, any of the devices shown in FIGS. 3-4. For example, process 800 may be executed by control circuitry 304 (FIG. 3) as instructed by control circuitry implemented on user equipment 402, 404, and/or 406 (FIG. 4) in order to receive a plurality of inputs identifying an indication of interest for each of a plurality of scenes for a media asset. In addition, one or more steps of process 800 may be incorporated into, or combined with, one or more steps of any other process or embodiment.

Although the following steps of the flowchart will be discussed as predominantly being performed by a control circuitry 304 of a user equipment device, it should be understood that each and any of the illustrative steps of process 900 described in the flowchart may be performed by control circuitry of a server (e.g., media content source 416, media guidance data source 418, or any other suitable server), control circuitry of user equipment device 300, any other suitable server or source, and/or any combination thereof.

At step 910, control circuitry 304 determines that a user, using a first platform (e.g., an electronic program guide platform), accessed by a user equipment device (e.g., any of 402, 404, 406 of FIG. 4) has viewed a first advertisement (e.g., a video commercial for an upcoming movie, “Wrecked”, as generated for display in display 500 of FIG. 5 at any time points) of a plurality of advertisements (e.g., that correspond to first metadata which includes fields such as “Movie”, “Wrecked”). In response to determining that the user has viewed the first advertisement of the plurality advertisements, using the first platform (e.g., an electronic program guide application platform as accessed by any of user equipment devices 402, 404, and 406), the process proceeds to step 920, otherwise the process polls on step 910.

In some embodiments, control circuitry 304 of a user equipment device (e.g., any of 402, 404, and 406) may determine that the user who is using the first platform has viewed the first advertisement (e.g., a graphical image for the upcoming movie, “Wrecked”) by receiving an indication from the first platform that the user has remained at a location proximate to a display of the first advertisement for a minimum period of time. For example, control circuitry of a user equipment device (e.g., a tablet computer used as an electronic signboard device) may determine that the user has remained in a location proximate to the user equipment device used as the signboard based on a location of the user determined using location circuitry 318 and control circuitry of a wireless PDA 406 carried by the user. For example, control circuitry of a user television equipment device 402 may determine that a user has remained in a location proximate to the user television equipment device 402 based on determining that the face and/or eyes of a user are detected proximate to the user television

In some aspects, the first advertisement that corresponds to the first metadata is a video generated for display during at least one of a scheduled transmission of a media asset (e.g., a broadcast program), an unscheduled transmission of a media asset (e.g., an on-demand program), or an unscheduled playback of a media asset (e.g., a media asset recorded on a DVR). For example, control circuitry of a user television equipment 402 may determine that, during a broadcast television program, a first video commercial advertisement was generated for display to a user.

In some aspects, control circuitry of a server or a user television equipment may receive an indication from the first platform (e.g., an electronic program guide application platform) that the video of the first advertisement (e.g., a video for an upcoming movie “Wrecked”) corresponding to first metadata (e.g., Media->Movie->Title->“Wrecked”) is generated for display for a minimum period of time, and, in response, increment the count of the number of times that the user has viewed any advertisement that corresponds to the first metadata. For example, control circuitry of a server or of a user television equipment may determine that a user has viewed a commercial for an upcoming movie by determining that the video has been displayed for a minimum amount of time without interruption from fast-forward commands, stop or change channel commands.

In some aspects, control circuitry 304 of a server or a user equipment device (e.g., any of 402, 404 or 406 of FIG. 4) may determine a level of sufficient interest by the user in the video of the first advertisement based on an attentiveness level of the first user received from imaging circuitry 316. For example, a user television equipment may include a camera. Control circuitry 304 of the user television equipment may determine, based on images and/or video received from imaging circuitry 316, that a user's face and eyes are detected and directed towards a display of the user television equipment 402 for a minimum period of time during display of the video of the first advertisement (e.g., video of a commercial for a movie). Additionally, control circuitry 304 may determine that the frequency with which a user looks away from a display of the user television equipment in order to determine a level of sufficient interest.

At step 920, in response to determining that a user has viewed a first plurality of advertisements (e.g., generated for display via any of FIGS. 1-2, 5-6), control circuitry of a server may increment a count of the number of times that the user has viewed any advertisement of the plurality of advertisements (e.g., corresponding to the first metadata).

At step 930, control circuitry of a server or a user equipment device (e.g., any of 402, 404 or 406 of FIG. 4) may determine whether the count exceeds a threshold. For example, control circuitry may determine that the count exceeds a threshold, indicating that retargeting of advertisements from the first platform (e.g., the electronic program guide application platform) to a second platform (e.g., a social network platform) should take place. In response to determining that the count exceeds a threshold, the process proceeds to step 940, otherwise the process returns to step 910.

At step 940, control circuitry of a server or a user equipment device (e.g., any of 402, 404 or 406 of FIG. 4) may calculate a plurality of correlation metrics between first metadata and metadata of each of a plurality of candidate advertisements. For example, control circuitry may calculate a plurality of correlation metrics between the first metadata (e.g., for the music band) and metadata of each of a plurality of candidate advertisements (e.g., a plurality of advertisements related to upcoming performances for the same music band or several different music bands).

In some aspects, control circuitry of a server may calculate the plurality of correlation metrics between the first metadata of the first plurality of advertisements and the metadata of each of the candidate advertisements by determining a count of intersecting metadata fields between the first metadata and the metadata of each of the candidate advertisements. For example, first metadata may include the fields (Car->Sedan->Lexus) and metadata of a first candidate advertisement may include the fields (Car->SUV->Honda->TestDrive) and a second candidate advertisement may include the fields (Car->SUV->Lexus->Testdrive). Control circuitry may determine that a correlation metric between the first metadata and metadata of the first candidate advertisement is the value 1 (e.g., 1 intersection of the “Car” field), and may determine that a correlation metric between the first metadata and metadata of the second candidate advertisement is the number 2 (e.g., 2 intersections of the fields “Car” and “Lexus”). The correlation metrics may be used to select the candidate advertisement for display. For example, control circuitry may select the second candidate advertisement (e.g., corresponding to metadata Car->SUV->Lexus->Testdrive) having the highest correlation metric among the two candidate advertisements.

At step 950, control circuitry may select a second advertisement from the plurality of candidate advertisements. For example, control circuitry may select a second advertisement (e.g., for a test drive of a Lexus SUV, corresponding to the Lexus car commercial of the first advertisement) that has a highest correlation metric of the plurality of correlation metrics to find a best match between the first advertisement and the second advertisement of the plurality of candidate advertisements.

At step 960, control circuitry may cause to be displayed, the second advertisement to the user by way of the second platform (e.g., in any of FIG. 1-2, 5-6). For example, control circuitry may cause the second advertisement (e.g., for the test drive offer for a Lexus SUV) to be displayed by way of the second platform (e.g., the social network platform) that is different from the first platform (e.g., the electronic program guide application platform), for display to the user.

In some aspects, control circuitry may receive a record of an access event by the user by way of the second platform, calculate a second correlation metric between metadata of the access event and the metadata of the second advertisement. Control circuitry may then determine that the second correlation metric exceeds a threshold and, in response, cause the second advertisement to be displayed using the second platform. For example, control circuitry may receive a notification that a user has accessed a social network platform via a web browser (e.g., detected by receipt of a cookie from the web browser) and is viewing a page related to SUV cars. Control circuitry may calculate a correlation metric by comparing metadata for the web page (e.g., Car->SUV), and metadata for a selected second advertisement (e.g., Car->SUV->Lexus->Testdrive) as the value 2, and determine that it exceeds a threshold (e.g., 1). In response control circuitry of a server may cause the selected second advertisement to be displayed at the webpage.

In some aspects, control circuitry may determine that the user using the first platform and that the user viewing the advertisement by way of the second platform are the same user based on at least one of an e-mail address, a phone number, an IP address, a MAC address, a user identification number and a cookie. For example, control circuitry of a server may determine that a user of a first platform (e.g., an e-mail platform), and a user of a second platform (e.g., a social network), are a same user based on the e-mail address the user used to access both platforms.

In some embodiments, control circuitry may receive a first record of when a user viewed the first advertisement on the first platform and a second record of when the user viewed the second advertisement on the second platform. For example, control circuitry of a server may determine that a user has viewed an advertisement based on a first record received from a user television equipment used to access the first platform. The record may include an identifier of a profile of the user, an identifier of the first advertisement, and a time stamp of when the user viewed the first advertisement. The record may also include an identifier of the first platform. In some aspects, the record may not include an identifier of the first platform if the control circuitry receives the first record using the first platform. For example, control circuitry of a server may determine that a user has viewed an advertisement based on a second record received from a user equipment device used to access the second platform (e.g., an e-mail service). The record may include an identifier of a profile of the user, an identifier of the second advertisement, and a time stamp of when the user viewed the first advertisement. The record may also include an identifier of the first platform. In some aspects, the record may not include an identifier of the first platform if the control circuitry receives the first record using the first platform.

FIG. 10 is a flowchart 1000 of illustrative steps involved in determining a retargeting sequence for displaying advertisements to a user through multiple platforms in accordance with some embodiments of the disclosure. It should be noted that process 800 or any step thereof could be performed on, or provided by, any of the devices shown in FIGS. 3-4. For example, process 1000 may be executed by control circuitry 304 (FIG. 3) as instructed by control circuitry implemented on user equipment 402, 404, and/or 406 (FIG. 4) in order to receive a plurality of inputs identifying an indication of interest for each of a plurality of scenes for a media asset. In addition, one or more steps of process 1000 may be incorporated into or combined with one or more steps of any other process or embodiment.

Although the following steps of the flowchart will be discussed as predominantly being performed by a control circuitry 304 of a user equipment device, it should be understood that each and any of the illustrative steps of process 800 described in the flowchart may be performed by control circuitry of a server (e.g., media content source 416, media guidance data source 418, or any other suitable server), control circuitry of user equipment device 300, any other suitable server or source, and/or any combination thereof.

At step 1010, control circuitry (e.g., of a server or a user equipment device 402, 404 or 406 of FIG. 4) determines that a user using a first platform has viewed a first plurality of advertisements (e.g., that corresponds to first metadata). For example, control circuitry may determine when a user, using the first platform (e.g., an electronic program guide platform) has viewed a first advertisement (e.g., a video commercial for an upcoming movie) of a first plurality of advertisements that correspond to first metadata (e.g., Media->Movie->Title->“Wrecked”; VideoAd).

At step 1020, control circuitry (e.g., of the server or a user equipment device 402, 404 or 406 of FIG. 4) determines when the user, using a second platform, has viewed a second advertisement of a second plurality of advertisements (e.g., corresponding to second metadata, where the second metadata is correlated to the first metadata and generated for display in any of FIGS. 1-2 and 5-6). The control circuitry may determine when the user, using the second platform (e.g., a social network platform), has viewed a second advertisement (e.g., an advertisement 620 of an upcoming Movie as shown in display 600 of FIG. 6) of a second plurality of advertisements corresponding to second metadata, where the second metadata and the first metadata are correlated (e.g., by a highest number of matches of metadata fields).

At step 1030, control circuitry (e.g., of the server or a user equipment device 402, 404 or 406 of FIG. 4) determines that a conversion event has occurred within a predefined time from a time at which the user viewed an advertisement. The control circuitry may determine that within a predefined period from a time at which the user viewed (e.g., using the social network platform and generated for display in any of FIGS. 1-2 and 5-6) an advertisement of the second plurality of advertisements, that a first conversion event (e.g., a selection of the advertisement) has occurred by way of the second platform. In response to determining that a conversion event has occurred within the predetermine time, the process proceeds to step 1040, otherwise the proceeds to step 1035.

In some aspects, the first conversion event may include determining that the user has remained at a location correlated to the first metadata (e.g., Car->Sedan->Lexus) and the second metadata (e.g., Car->Sedan->Lexus; Dealership->Address1) for a minimum period of time. For example, control circuitry of a user equipment device may determine that a user has entered a Lexus car dealership at Address 1 and remained at the dealership for longer than 10 minutes. The first conversion event may include receiving a user selection of the second advertisement. For example, control circuitry of a user equipment device may receive a selection of a video advertisement that was generated for display to the user using a social network platform. The first conversion event may include receiving an order of an item correlated to the first metadata and the second metadata. For example, control circuitry of a server may generate for display (e.g., in display 600 of FIG. 6 for an e-mail platform) a series of advertisements related to a chess program using a first platform (e.g., the e-mail platform). Control circuitry may receive an order to download the chess board game to a user equipment device of a user, through a second platform (e.g., a social network platform) through a selection of an advertisement generated for display in the second platform (e.g., in display 600 of FIG. 6 for the social network platform).

At step 1040, control circuitry (e.g., of the server or a user equipment device 402, 404 or 406 of FIG. 4) determines a retargeting sequence for subsequent display, by way of the first platform and the second platform, of advertisements selected from the first plurality of advertisements and the second plurality of advertisements in response to determining that the first conversion event has occurred. The control circuitry may determine a retargeting sequence for subsequent display, by way of the first platform and the second platform, of advertisements selected from the first plurality of advertisements (e.g., video commercials for Lexus cars generated for display in any of FIGS. 1-2 and 5 in an electronic program guide application platform) and the second plurality of advertisements (e.g., advertisements embedded in a webpage or mobile application related to Lexus Cars as generated for display in display 600 of FIG. 6), in response to determining that the first conversion event has occurred.

In some embodiments, control circuitry 304 (e.g., of the server or a user equipment device 402, 404 or 406 of FIG. 4) may store to a first data structure (e.g., to storage 308), time stamps of when the user viewed, using the first platform, any advertisements of the first plurality of advertisements. For example, control circuitry 304 may store (e.g., to storage 308) a number of records including a time stamp of when an advertisement was generated for display or viewed, an identifier of the advertisement, and/or an identifier of the first platform used. Control circuitry 304 may store to a second data structure, time stamps of when the user viewed, using the second platform, any advertisements of the second plurality of advertisements. For example, control circuitry may store a number of records including a time stamp of when an advertisement was generated for display or viewed, an identifier of the advertisement, and/or an identifier of the second platform used.

Control circuitry 304 (e.g., of the server or a user equipment device 402, 404 or 406 of FIG. 4) may determine the retargeting sequence by ordering the time stamps stored (e.g., to storage 308) in the first data structure and the time stamps stored (e.g., to storage 308) in the second data structure. For example, control circuitry may load the records of the first data structure, and the records of the second data structure into a database, and store the database by time stamp to generate a sequence in which advertisements were displayed using the first platform and second platform. Control circuitry 304 may generate a sequence in which advertisements from the first plurality of advertisements and the second plurality of advertisements are displayed, based on the ordering of the time stamps stored in the first data structure and the time stamps stored in the second data structure, wherein the sequence comprises a pluralities of entries indicating the first platform or the second platform. For example, control circuitry may generate a new data structure based on an export of the sorted records from the database. Control circuitry may store, as part of the retargeting sequence, the generated sequence. For example, control circuitry may store the new data structure as part of a data structure for the retargeting sequence that may include other information such as rules.

In some embodiments, control circuitry 304 (e.g., of the server or a user equipment device 402, 404 or 406 of FIG. 4) may increment a first count of a number of times that the user has viewed any advertisement of the first plurality of advertisements in response to determining that the user has viewed the first advertisement. For example, control circuitry may increment a count of a number of times that a user has viewed advertisements for an upcoming movie, “Wrecked”, on a first platform (e.g., any of advertisements 610, 620,630 and 640 as shown in display 600 of FIG. 6) on a social network platform. Control circuitry 304 may determine the retargeting sequence further by setting the first threshold to 2 based on the first count of 3 of the number of times advertisements related to the upcoming movie have been viewed. For example, after the first conversion event (e.g., a selection of a movie advertisement 620 on a social network platform) has occurred, control circuitry 304 may determine that a count of the number of advertisements on the first platform (e.g., a count of the number of advertisements at 610, 620, 630 and 640 generated for display through the social network platform), is 3, and store the number as a threshold. Control circuitry may store, as part of the retargeting sequence, the first threshold 2 and a rule to transmit, by way of the second platform, an advertisement selected from the second plurality of advertisements for display to the user in response to determining that an incrementing of the first count caused the first count to exceed the first threshold. For example, control circuitry may store, to a data structure for the retargeting sequence, the first threshold and metadata for first metadata and a rule that upon determining that a count of the number of times that a user has viewed any advertisements correlated to the first metadata using the first platform, exceeds the first threshold, the control circuitry should transition from displaying advertisements on a first platform to a second platform.

At step 1050, control circuitry (e.g., of the server or a user equipment device 402, 404 or 406 of FIG. 4) executes the retargeting sequence, where the retargeting sequence includes causing to be displayed by way of the first platform, an advertisement of the first plurality of advertisements, and by way of the second platform, an advertisement of the second plurality of advertisements.

The control circuitry may execute the retargeting sequence, where the retargeting sequence includes causing to be displayed by way of the first platform, an advertisement (e.g., advertisement 620 for a movie as shown in display 600 of FIG. 6 for a social network platform) of the first plurality of advertisements, and by way of the second platform, an advertisement (e.g., a thumbnail advertisement of the movie as generated for display in an e-mail platform) of the second plurality of advertisements.

In some embodiments, control circuitry (e.g., of the server or a user equipment device 402, 404 or 406 of FIG. 4) may execute the retargeting sequence by determining that a first entry of the sequence indicates the first platform. For example, control circuitry 304 may determine that a first record of the new data structure includes an identifier of the first platform. Control circuitry may, in response to determining that the first entry of the sequence indicates the first platform, cause an advertisement of the first plurality of advertisements to be displayed, by way of the first platform, to the user. For example, control circuitry may select an advertisement from the first plurality of advertisements (e.g., correlated by first metadata) and generate for display (e.g., in any of FIGS. 1-2 and 5-6) the advertisement using the first platform. Control circuitry may determine that a second entry of the sequence indicates the second platform. For example, control circuitry may determine that a second record of the new data structure includes an identifier of the second platform. Control circuitry may, in response to determining that the second entry of the sequence indicates the second platform, cause an advertisement of the second plurality of advertisements (e.g., correlated by second metadata) to be displayed (e.g., in any of FIGS. 1-2 and 5-6), by way of the second platform, to the user. For example, control circuitry may select an advertisement of the second plurality of advertisements and generate for display the advertisement to the user.

In some aspects, control circuitry 304 may store a time stamp of when the first conversion event occurred, for example, as part of the data structure for the retargeting sequence. Determining the predicted time of occurrence of the second conversion event may include calculating a difference between the time stamp of when the first conversion event occurred and a time stamp stored in the first data structure, of when the user first viewed an advertisement of the first plurality of advertisements, and adding the difference to a time stamp of a first transmission of an advertisement of the first plurality of advertisements during the execution of the retargeting sequence. For example, control circuitry may determine that the first conversion event (e.g., selection of an advertisement on a social network platform) took place at 10 AM, while the first viewed advertisement was viewed at 9 AM using the first platform (e.g., an electronic program guide application). Control circuitry may determine a difference of 1 hour, and add this difference to an 11:00 AM start time of a subsequent series of advertisements according to the order of the retargeting sequence.

In some embodiments, control circuitry may execute the retargeting sequence by resetting the first count and loading the rule from the retargeting sequence. For example, control circuitry may reset the first count in order to start a new iteration of generating for display advertisements using the first platform and the second platform according to a determined retargeting sequence. Control circuitry may load the rule to retarget from the first platform to the second platform in response to determining that a count of advertisements related to first metadata stored in the data structure for the retargeting sequence exceeds the first threshold. Control circuitry may determine that the user has viewed, using the first platform, any advertisement of the first plurality of advertisements, and increment the first count in response to determining that the user has viewed, using the first platform, any advertisement of the first plurality of advertisements. For example, control circuitry may determine that a user has viewed an advertisement related to an upcoming movie based on first metadata (Media->Movie->Title->“Wrecked”).

Control circuitry 304 may determine that the first count exceeds the first threshold, and cause the second advertisement to be displayed, by way of the second platform, to the user in response to determining that the first count exceeds the first threshold and in response to loading the rule. For example, control circuitry may determine that a user may determine that a user has viewed advertisements for the upcoming movie, “Wrecked”, 3 times, which exceeds the first threshold of 2, and based on the loaded rule to transition to the second platform when the count exceeds the first threshold, determine that the next advertisements should be generated for display on the second platform.

At step 1060, control circuitry (e.g., of the server) determines a predicted time of occurrence of a second conversion event. The control circuitry may determine a predicted time of occurrence of the second conversion event (e.g., a second section of an advertisement displayed using the second platform), based on, for example, a time difference between a time of display of the first advertisement in a prior sequence and a time of the first conversion event.

At step 1070, control circuitry (e.g., of the server) determines whether the predicted time of conversion has yet been reached. In response to determining that the predicted time of occurrence has been reached, the process proceeds to step 1080, otherwise the process polls on step 1070. The control circuitry might determine the predicted time of the second conversion event as the time of display of the first advertisement in the retargeting sequence, added to the time difference from the prior sequence.

At step 1080, control circuitry (e.g., of the server) causes an advertisement from the second plurality of advertisements having a highest correlation to the first metadata, to be displayed to the user at the predicted time of occurrence of the second conversion event. The control circuitry may determine cause to be displayed by way of the second platform, an advertisement from the second plurality of advertisements having a highest correlation to the first metadata (e.g., a video advertisement for a Lexus car that can be generated for display within a web page of the social network platform), to the user at the predicted time of occurrence of the second conversion event.

It is contemplated that the steps or descriptions of FIG. 9 and FIG. 10 may be used with any other embodiment of this disclosure. In addition, the steps and descriptions described in relation to FIG. 9 and FIG. 10 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 9 and FIG. 10.

It will be apparent to those of ordinary skill in the art that methods involved in the present disclosure may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present disclosure may be executed using processing circuitry. For instance, determination of media asset ranking may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, or media guidance data source 418. For example, the media asset attributes as described herein may be stored in, and retrieved from, storage 308 of FIG. 3, or media guidance data source 418 of FIG. 4. Furthermore, processing circuitry, or a computer program, may update settings associated with a user, such as user profile preferences, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for retargeting advertisements, the method comprising:
determining when a user, using a first platform, has viewed a first advertisement of a first plurality of advertisements that corresponds to first metadata;
determining when the user, using a second platform, has viewed a second advertisement of a second plurality of advertisements corresponding to second metadata, wherein the second metadata is correlated to the first metadata;
determining that, within a predefined period from a time at which the user viewed an advertisement of the second plurality of advertisements, a first conversion event has occurred by the user by way of the second platform;
determining a retargeting sequence for subsequent display, by way of the first platform and the second platform, of advertisements selected from the first plurality of advertisements and the second plurality of advertisements in response to determining that the first conversion event has occurred;
executing the retargeting sequence, wherein the retargeting sequence comprises causing to be displayed, by way of the first platform, an advertisement of the first plurality of advertisements, and by way of the second platform, an advertisement of the second plurality of advertisements;
determining a predicted time of occurrence of a second conversion event; and
causing to be displayed, by way of the second platform, an advertisement from the second plurality of advertisements having a highest correlation to the first metadata, to the user at the predicted time of occurrence of the second conversion event.

2. The method of claim 1, wherein the first conversion event comprises at least one of:
determining that the user has remained at a location correlated to the first metadata and the second metadata for a minimum period of time, receiving a user selection of the second advertisement, and receiving an order of an item correlated to the first metadata and the second metadata.

3. The method of claim 1, further comprising:
storing, to a first data structure, time stamps of when the user viewed, using the first platform, any advertisements of the first plurality of advertisements;
storing, to a second data structure, time stamps of when the user viewed, using the second platform, any advertisements of the second plurality of advertisements; and
wherein the determining of the retargeting sequence further comprises:
ordering the time stamps stored in the first data structure and the time stamps stored in the second data structure;
generating a sequence in which advertisements from the first plurality of advertisements and the second plurality of advertisements are displayed, based on the ordering of the time stamps stored in the first data structure and the time stamps stored in the second data structure, wherein the sequence comprises a plurality of entries indicating the first platform or the second platform; and
storing, as part of the retargeting sequence, the generated sequence.

4. The method of claim 3, wherein executing the retargeting sequence further comprises:
determining that a first entry of the sequence indicates the first platform;
in response to determining that the first entry of the sequence indicates the first platform, causing an advertisement of the first plurality of advertisements to be displayed, by way of the first platform, to the user;
determining that a second entry of the sequence indicates the second platform;
in response to determining that the second entry of the sequence indicates the second platform, causing an advertisement of the second plurality of advertisements to be displayed, by way of the second platform, to the user.

5. The method of claim 4, further comprising:
storing a time stamp of when the first conversion event occurred,
wherein the determining the predicted time of occurrence of the second conversion event further comprises:
calculating a difference between the time stamp of when the first conversion event occurred and a time stamp stored in the first data structure, of when the user first viewed an advertisement of the first plurality of advertisements; and
adding the difference to a time stamp of a first transmission of an advertisement of the first plurality of advertisements during the executing of the retargeting sequence.

6. The method of claim 1, further comprising:
incrementing a first count of a number of times that the user has viewed any advertisement of the first plurality of advertisements in response to determining that the user has viewed the first advertisement; and
wherein the determining of the retargeting sequence further comprises:
setting the first threshold based on the first count; and
storing, as part of the retargeting sequence, the first threshold and a rule to transmit, by way of the second platform, an advertisement selected from the second plurality of advertisements for display to the user in response to determining that an incrementing of the first count caused the first count to exceed the first threshold.

7. The method of claim 6, wherein the executing the retargeting sequence further comprises:
resetting the first count;
loading the rule from the retargeting sequence;
determining that the user has viewed, using the first platform, any advertisement of the first plurality of advertisements;
incrementing the first count in response to determining that the user has viewed, using the first platform, any advertisement of the first plurality of advertisements;
determining that the first count exceeds the first threshold;
causing the second advertisement to be displayed, by way of the second platform, to the user in response to determining that the first count exceeds the first threshold and in response to loading the rule.

8. The method of claim 1, wherein the determining that the user has interacted, via the first platform, with the first advertisement corresponding to the first set of metadata further comprises:
receiving an indication, via the first platform, that the user has remained at a location proximate to a display of the first advertisement for a minimum period of time.

9. The method of claim 1, wherein the first platform is an electronic program guide application.

10. The method of claim 9, wherein the first advertisement corresponding to the first set of metadata is a video generated for display during at least one of a scheduled transmission of a media asset, an unscheduled transmission of a media asset, or an unscheduled playback of a media asset.

11. A system for retargeting advertisements, the system comprising:
control circuitry configured to:
determine when a user, using a first platform, has viewed a first advertisement of a first plurality of advertisements that corresponds to first metadata;
determine when the user, using a second platform, has viewed a second advertisement of a second plurality of advertisements corresponding to second metadata, wherein the second metadata is correlated to the first metadata;
determine that, within a predefined period from a time at which the user viewed an advertisement of the second plurality of advertisements, a first conversion event has occurred by the user by way of the second platform;
determine a retargeting sequence for subsequent display, by way of the first platform and the second platform, of advertisements selected from the first plurality of advertisements and the second plurality of advertisements in response to determining that the first conversion event has occurred;
execute the retargeting sequence, wherein the retargeting sequence comprises causing to be displayed, by way of the first platform, an advertisement of the first plurality of advertisements, and by way of the second platform, an advertisement of the second plurality of advertisements;
determine a predicted time of occurrence of a second conversion event; and
causing to be displayed, by way of the second platform, an advertisement from the second plurality of advertisements having a highest correlation to the first metadata, to the user at the predicted time of occurrence of the second conversion event.

12. The system of claim 11, wherein the first conversion event comprises at least one of:
determining that the user has remained at a location correlated to the first metadata and the second metadata for a minimum period of time, receiving a user selection of the second advertisement, and receiving an order of an item correlated to the first metadata and the second metadata.

13. The system of claim 11, wherein the control circuitry is further configured to:
store, to a first data structure, time stamps of when the user viewed, using the first platform, any advertisements of the first plurality of advertisements;
store, to a second data structure, time stamps of when the user viewed, using the second platform, any advertisements of the second plurality of advertisements;
order the time stamps stored in the first data structure and the time stamps stored in the second data structure;
generate a sequence in which advertisements from the first plurality of advertisements and the second plurality of advertisements are displayed, based on the ordering of the time stamps stored in the first data structure and the time stamps stored in the second data structure, wherein the sequence comprises a plurality of entries indicating the first platform or the second platform; and
store, as part of the retargeting sequence, the generated sequence.

14. The system of claim 13, wherein the control circuitry is further configured to:
determine that a first entry of the sequence indicates the first platform;
cause, in response to determining that the first entry of the sequence indicates the first platform, an advertisement of the first plurality of advertisements to be displayed, by way of the first platform, to the user;
determine that a second entry of the sequence indicates the second platform;
cause, in response to determining that the second entry of the sequence indicates the second platform, an advertisement of the second plurality of advertisements to be displayed, by way of the second platform, to the user.

15. The system of claim 14, wherein the control circuitry is further configured to:
store a time stamp of when the first conversion event occurred;
calculate a difference between the time stamp of when the first conversion event occurred and a time stamp stored in the first data structure, of when the user first viewed an advertisement of the first plurality of advertisements; and
add the difference to a time stamp of a first transmission of an advertisement of the first plurality of advertisements during the executing of the retargeting sequence.

16. The system of claim 11, wherein the control circuitry is further configured to:
increment a first count of a number of times that the user has viewed any advertisement of the first plurality of advertisements in response to determining that the user has viewed the first advertisement;
set the first threshold based on the first count; and
store, as part of the retargeting sequence, the first threshold and a rule to transmit, by way of the second platform, an advertisement selected from the second plurality of advertisements for display to the user in response to determining that an incrementing of the first count caused the first count to exceed the first threshold.

17. The system of claim 16, wherein the control circuitry is further configured to:
reset the first count;
load the rule from the retargeting sequence;
determine that the user has viewed, using the first platform, any advertisement of the first plurality of advertisements;
increment the first count in response to determining that the user has viewed, using the first platform, any advertisement of the first plurality of advertisements;
determine that the first count exceeds the first threshold;
cause the second advertisement to be displayed, by way of the second platform, to the user in response to determining that the first count exceeds the first threshold and in response to loading the rule.

18. The system of claim 11, wherein the control circuitry is further configured to:
receive an indication, via the first platform, that the user has remained at a location proximate to a display of the first advertisement for a minimum period of time.

19. The system of claim 11, wherein the first platform is an electronic program guide application.

20. The system of claim 19, wherein the first advertisement corresponding to the first set of metadata is a video generated for display during at least one of a scheduled transmission of a media asset, an unscheduled transmission of a media asset, or an unscheduled playback of a media asset.

21-50. (canceled)
